(19) United States
(12) Patent Application Publication
(10) Pub. No.: US 2024/0137789 A1
(43) Pub. Date: Apr. 25, 2024

(54) APPLYING WEIGHTED AVERAGING TO MEASUREMENTS ASSOCIATED WITH REFERENCE SIGNALS

(71) Applicant: QUALCOMM Incorporated, San Diego, CA (US)

(72) Inventors: Tianyang BAI, Somerville, NJ (US); Yan ZHOU, San Diego, CA (US); Hua WANG, Basking Ridge, NJ (US); Junyi LI, Fairless Hills, PA (US); Tao LUO, San Diego, CA (US)

(21) Appl. No.: 18/048,568

(22) Filed: Oct. 20, 2022

(51) Int. Cl. H04W 24/08; H04B 17/318; H04W 24/10; H04W 72/04

(52) U.S. Cl. CPC H04W 24/08; H04B 17/318; H04W 24/10; H04W 72/0413

(57) ABSTRACT

Various aspects of the present disclosure generally relate to wireless communication. In some aspects, a user equipment (UE) may receive, from a network node, a configuration for applying weighted averaging to layer 1 (L1) reference signal received power (RSRP) measurements. The UE may receive, from the network node, a plurality of reference signals during a period of time, the plurality of reference signals being quasi-co-located with each other. The UE may obtain weighted averaged L1 RSRP measurements associated with the plurality of reference signals based at least in part on the configuration, the weighted averaged L1 RSRP measurements being available as input to a machine learning (ML) model for beam prediction. Numerous other aspects are described.

### FIELD OF THE DISCLOSURE

Aspects of the present disclosure generally relate to wireless communication and to techniques and apparatuses for applying weighted averaging to measurements associated with reference signals.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a user equipment (UE) includes a memory and one or more processors, coupled to the memory, configured to: receive, from a network node, a configuration for applying weighted averaging to layer 1 (L1) reference signal received power (RSRP) measurements; receive, from the network node, a plurality of reference signals during a period of time, the plurality of reference signals being quasi-co-located with each other; and obtain weighted averaged L1 RSRP measurements associated with the plurality of reference signals based at least in part on the configuration, the weighted averaged L1 RSRP measurements being available as input to a machine learning (ML) model for beam prediction.

In some implementations, an apparatus for wireless communication at a network node includes a memory and one or more processors, coupled to the memory, configured to: transmit, to a UE, a configuration for applying weighted averaging to L1 RSRP measurements; transmit, to the UE, a plurality of reference signals during a period of time, the plurality of reference signals being quasi-co-located with each other; and receive, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction.

In some implementations, a method of wireless communication performed by an apparatus of a UE includes receiving, from a network node, a configuration for applying weighted averaging to L1 RSRP measurements; receiving, from the network node, a plurality of reference signals during a period of time, the plurality of reference signals being quasi-co-located with each other; and obtaining weighted averaged L1 RSRP measurements associated with the plurality of reference signals based at least in part on the configuration, the weighted averaged L1 RSRP measurements being available as input to an ML model for beam prediction.

In some implementations, a method of wireless communication performed by an apparatus of a network node includes transmitting, to a UE, a configuration for applying weighted averaging to L1 RSRP measurements; transmitting, to the UE, a plurality of reference signals during a period of time, the plurality of reference signals being quasi-co-located with each other; and receiving, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction.

In some implementations, a non-transitory computer-readable medium storing a set of instructions for wireless communication includes one or more instructions that, when executed by one or more processors of a UE, cause the UE to: receive, from a network node, a configuration for applying weighted averaging to L1 RSRP measurements; receive, from the network node, a plurality of reference signals during a period of time, the plurality of reference signals being quasi-co-located with each other; and obtain weighted averaged L1 RSRP measurements associated with the plurality of reference signals based at least in part on the configuration, the weighted averaged L1 RSRP measurements being available as input to an ML model for beam prediction.

In some implementations, a non-transitory computer-readable medium storing a set of instructions for wireless communication includes one or more instructions that, when executed by one or more processors of a network node, cause the network node to: transmit, to a UE, a configuration for applying weighted averaging to L1 RSRP measurements; transmit, to the UE, a plurality of reference signals during a period of time, the plurality of reference signals being quasi-co-located with each other; and receive, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction.

In some implementations, an apparatus for wireless communication includes means for receiving, from a network node, a configuration for applying weighted averaging to L1 RSRP measurements; means for receiving, from the network node, a plurality of reference signals during a period of time, the plurality of reference signals being quasi-co-located with each other; and means for obtaining weighted averaged L1 RSRP measurements associated with the plurality of reference signals based at least in part on the configuration, the weighted averaged L1 RSRP measurements being available as input to an ML model for beam prediction.

In some implementations, an apparatus for wireless communication includes means for transmitting, to a UE, a configuration for applying weighted averaging to L1 RSRP measurements; means for transmitting, to the UE, a plurality of reference signals during a period of time, the plurality of reference signals being quasi-co-located with each other; and means for receiving, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a machine learning (ML) model for beam prediction, in accordance with the present disclosure.

FIG. 5 is a diagram illustrating an example associated with applying weighted averaging to measurements associated with reference signals, in accordance with the present disclosure.

FIGS. 6-7 are diagrams illustrating example processes associated with applying weighted averaging to measurements associated with reference signals, in accordance with the present disclosure.

FIGS. 8-9 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

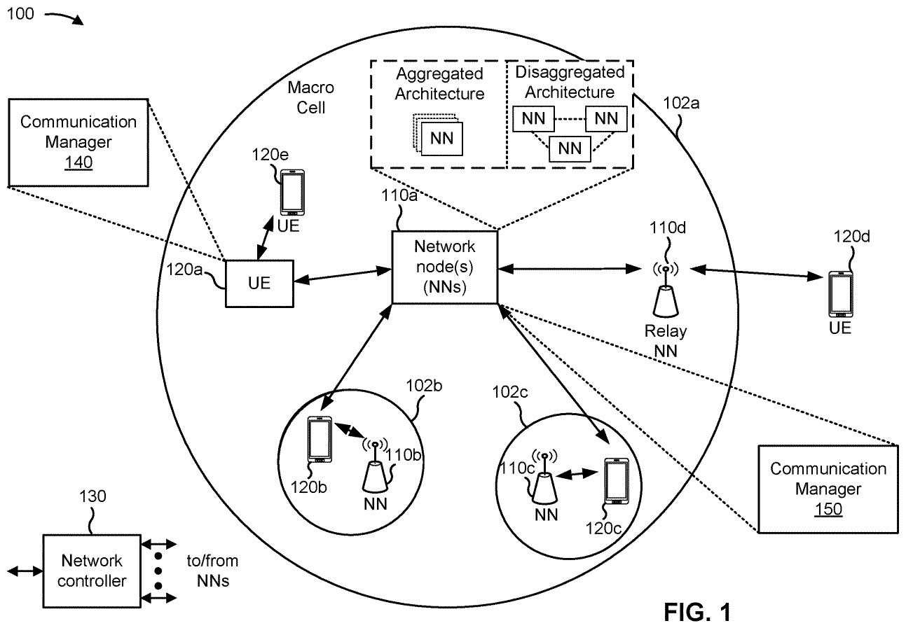

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (MC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a UE (e.g., UE 120) may include a communication manager 140. As described in more detail elsewhere herein, the communication manager 140 may receive, from a network node, a configuration for applying weighted averaging to layer 1 (L1) reference signal received power (RSRP) measurements; receive, from the network node, a plurality of reference signals during a period of time, the plurality of reference signals being quasi-co-located with each other; and obtain weighted averaged L1 RSRP measurements associated with the plurality of reference signals based at least in part on the configuration, the weighted averaged L1 RSRP measurements being available as input to a machine learning (ML) model for beam prediction. Additionally, or alternatively, the communication manager 140 may perform one or more other operations described herein.

In some aspects, a network node (e.g., network node 110) may include a communication manager 150. As described in more detail elsewhere herein, the communication manager 150 may transmit, to a UE, a configuration for applying weighted averaging to L1 RSRP measurements; transmit, to the UE, a plurality of reference signals during a period of time, the plurality of reference signals being quasi-co-located with each other; and receive, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction. Additionally, or alternatively, the communication manager 150 may perform one or more other operations described herein.

As indicated above, FIG. 1 is provided as an example. Other examples may differ from what is described with regard to FIG. 1.

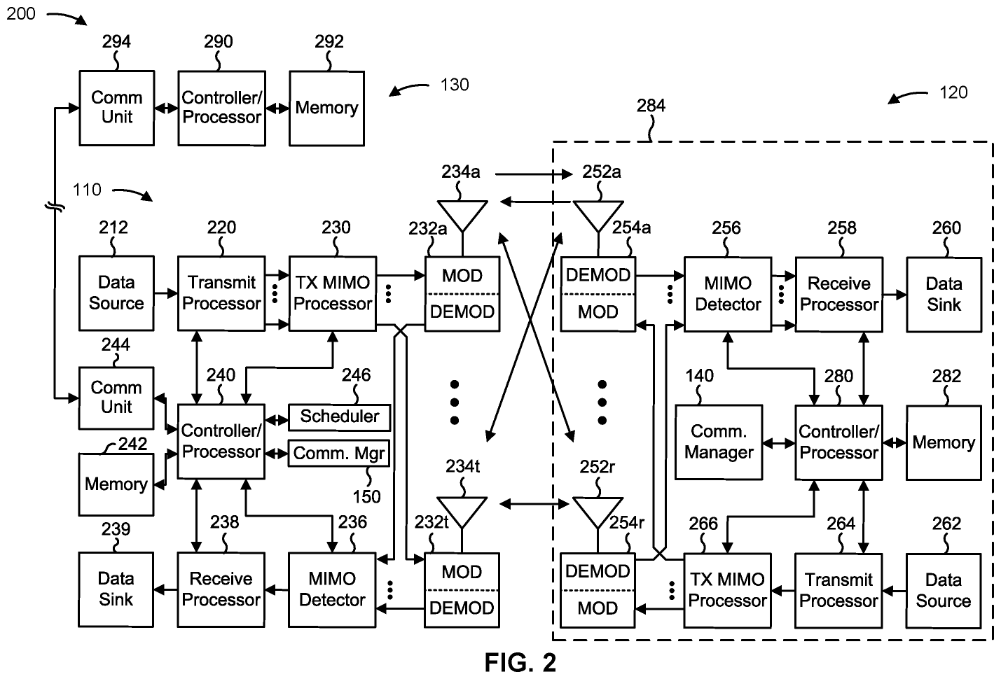

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MC S(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

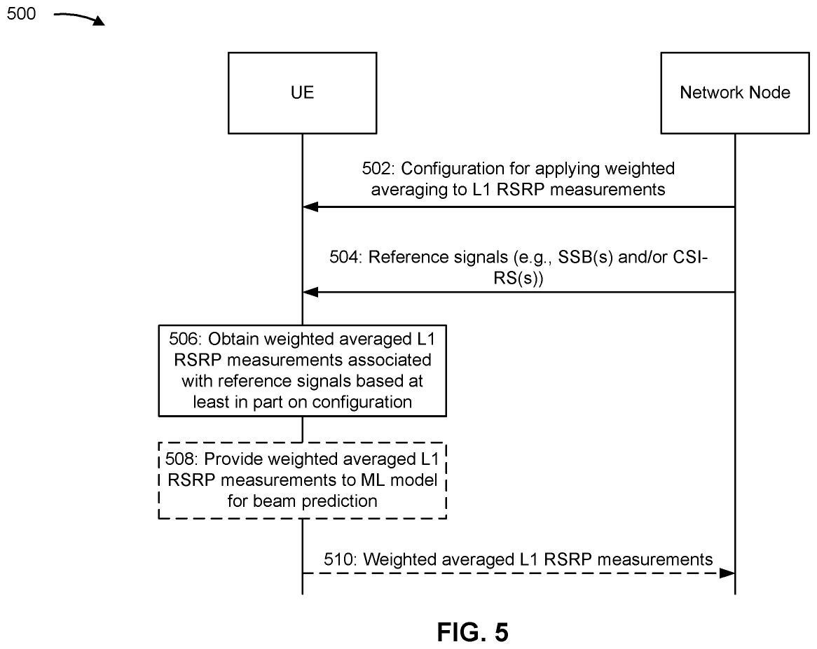

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-9).

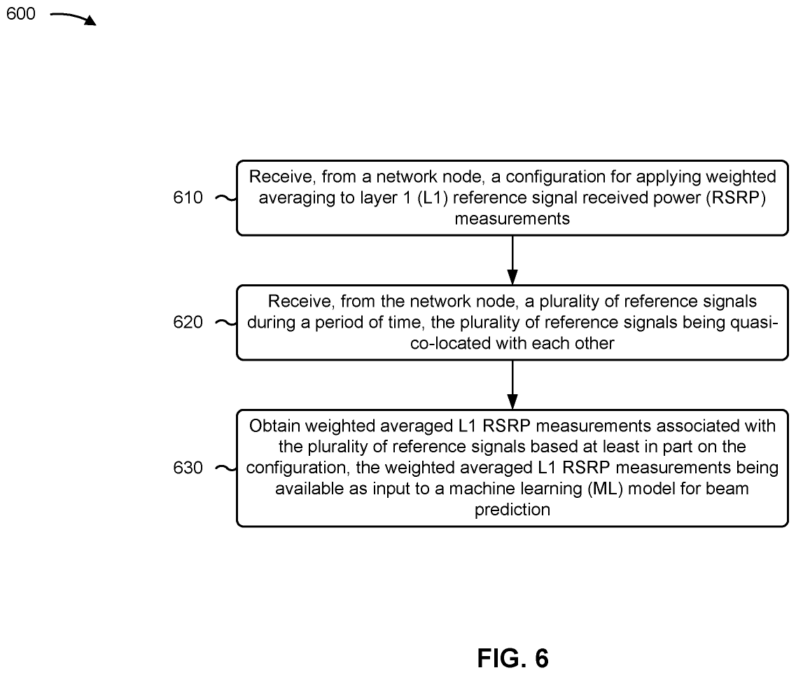

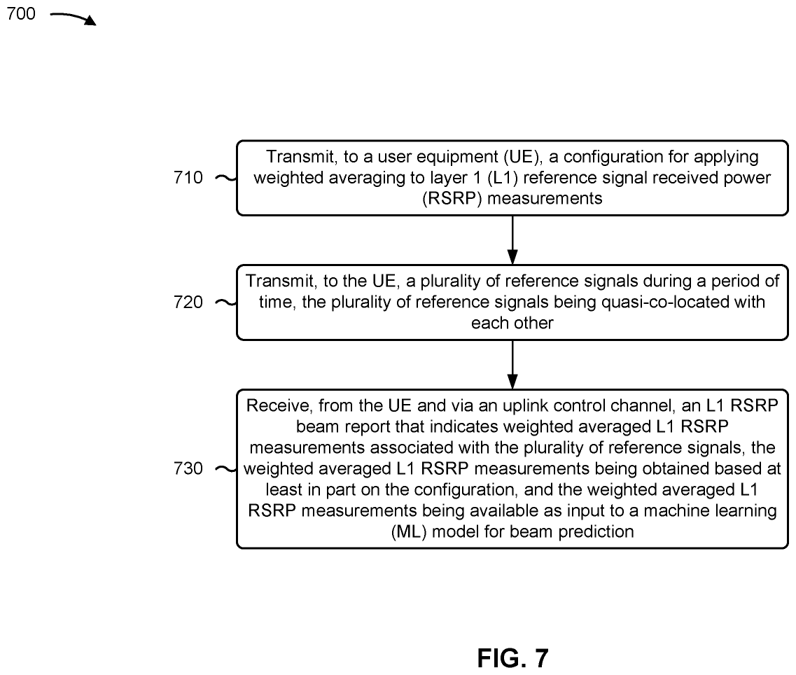

The controller/processor 240 of the network node 110, the controller/processor 280 of the UE 120, and/or any other component(s) of FIG. 2 may perform one or more techniques associated with applying weighted averaging to measurements associated with reference signals, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6, process 700 of FIG. 7, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6, process 700 of FIG. 7, and/or other processes as described herein. In some examples, executing instructions may include running the instructions, converting the instructions, compiling the instructions, and/or interpreting the instructions, among other examples.

In some aspects, a UE (e.g., UE 120) includes means for receiving, from a network node, a configuration for applying weighted averaging to L1 RSRP measurements; means for receiving, from the network node, a plurality of reference signals during a period of time, the plurality of reference signals being quasi-co-located with each other; and/or means for obtaining weighted averaged L1 RSRP measurements associated with the plurality of reference signals based at least in part on the configuration, the weighted averaged L1 RSRP measurements being available as input to an ML model for beam prediction. In some aspects, the means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., network node 110) includes means for transmitting, to a UE, a configuration for applying weighted averaging to L1 RSRP measurements; means for transmitting, to the UE, a plurality of reference signals during a period of time, the plurality of reference signals being quasi-co-located with each other; and/or means for receiving, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

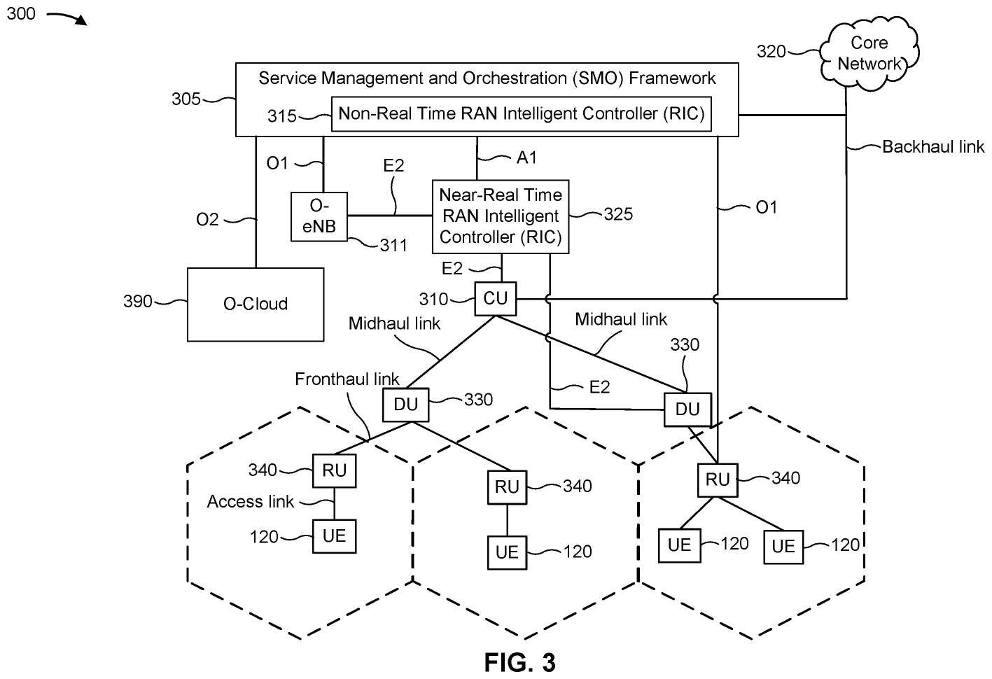

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

AWL for an air interface may be applicable to various use cases, such as channel state information (CSI) feedback enhancements (e.g., overhead reduction, improved accuracy, and/or prediction), beam management (e.g., beam prediction in time, and/or spatial domain for overhead and latency reduction, or beam selection accuracy improvement), and/or positioning accuracy enhancements for different scenarios (e.g., heavy non-line-of-sight (NLOS) conditions). An AWL framework may involve capability indications, configuration procedures (e.g., training and/or inference), validation and testing procedures, and management of data and an AWL model. AWL for a next generation (NG)-RAN may involve specifying data collection enhancements and signaling support over current NG-RAN interfaces and architecture (e.g., non-split architecture and split architecture) for AWL-based network energy saving, load balancing, and mobility optimization. Network entities and interface procedures may support data management and model management, which may include multi-vendor interoperability between different AI/ML functions (e.g., data collection, model training, and/or model inference), and/or an integration and collaboration of operations, administration, and maintenance (OAM) AWL, 5G core (5GC) AWL, NG-RAN AWL, and air interface AWL.

Beam prediction may involve using measurements (e.g., RSRP measurements) of a first beam set to predict metrics of a second beam set in a time domain and/or in a spatial domain. The second beam set may include the same beams or a different set of beams as compared to the first beam set. Predicted metrics may include upcoming RSRP measurements, best beam indexes, or other related metrics. A network node may train an ML model for beam prediction. The ML model for beam prediction may be run at a UE or at the network node. When the ML model for beam prediction is run at the network node only (e.g., the ML model for beam prediction is not run at the UE), the network node may configure the UE to obtain and report measurements. The network node may run the ML model for beam prediction based at least in part on the UE's reported measurements. The network node may perform a scheduling decision based at least in part on a beam prediction result. The UE may not report all local measurements. For example, the UE may only report measurements for a maximum quantity of beams, reported measurements may be quantized, and no receive (Rx) beam information may be available. In some cases, the UE may run the ML model for beam prediction based at least in part on a network node configuration. When the ML model for beam prediction is also configured at the UE, the network node may configure the ML model for beam prediction at the UE, and the UE may perform beam prediction based at least in part on measurements. The UE may report a beam prediction result to the network node.

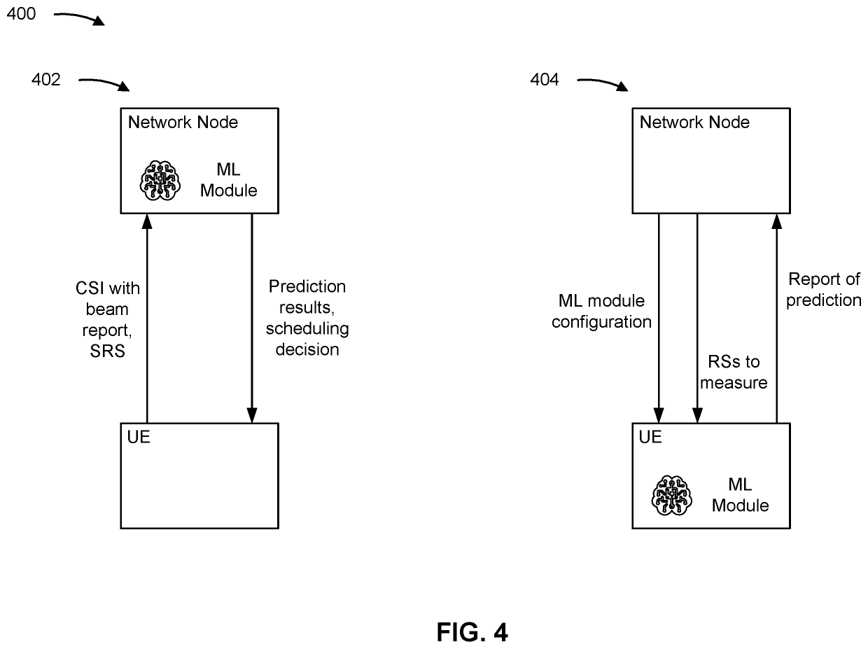

FIG. 4 is a diagram illustrating an example 400 of an ML model for beam prediction, in accordance with the present disclosure.

As shown by reference number 402, an ML model for beam prediction may run at a network node. A UE may feed back CSI with a beam report. The UE may feed back a sounding reference signal (SRS). The network node may run the ML model for beam prediction based at least in part on feedback received from the UE. The network node may determine a beam prediction result using the ML model for beam prediction. The network node may perform a scheduling decision for the UE based at least in part on the beam prediction result. The ML model for beam prediction may be run at the network node when the UE is power and/or computation power limited.

As shown by reference number 404, an ML model for beam prediction may be run at a UE. The ML model for beam prediction may be configured by a network node. The UE may run the ML model for beam prediction based at least in part on local measurements and signaling from the network node. The UE may report, to the network node, a beam prediction result based at least in part on a configuration or triggering condition. The UE may run the ML model for beam prediction because the UE may generally have more measurement results, as compared to the network node, and running the ML model for beam prediction at the UE may involve less overhead for reporting. However, running the ML model for beam prediction at the UE may involve a higher computation capability at the UE.

As indicated above, FIG. 4 is provided as an example. Other examples may differ from what is described with regard to FIG. 4.

Random fading may be an issue in an NLOS region. In the NLOS region, multi-paths may cause random fading, which may cause predicting the best beam/RSRP a challenging task. A UE may experience different RSRP measurements due to fading even along the same trajectory but in different realizations. In some cases, RSRP measurements may be similar, but may correspond to different optimal beams in different optimizations. A degree of randomness may be based at least in part on the quantity of multi-paths and an angular spread, and the degree of randomness may vary for different locations. An output of an NLOS beam prediction may be associated with uncertainly, which may make selecting a single optimal future beam challenging. An input of an ML model for beam prediction (e.g., an RSRP measurement) may have a relatively high level of randomness due to fading. In other words, the randomness of an ML model input may result in future beams being predicted with relatively high uncertainty, thereby degrading the performance of the UE and/or the network node.

In various aspects of techniques and apparatuses described herein, a UE may receive, from a network node, a configuration for applying weighted averaging to L1 RSRP measurements. The weighted averaging applied to the L1 RSRP measurements may be a local averaging of L1 RSRP measurements performed at the UE. The UE may receive, from the network node, a plurality of reference signals during a period of time. The plurality of reference signals may include one or more synchronization signal blocks (SSBs) and/or one or more channel state information reference signals (CSI-RSs). The plurality of reference signals may be quasi-co-located with each other. For example, one or more SSBs may be quasi-co-located with one or more CSI-RSs. As another example, one or more SSBs may be quasi-co-located with each other. As yet another example, one or more CSI-RSs may be quasi-co-located with each other. In other words, at least one SSB may be quasi-co-located with at least one CSI-RS. In some cases, multiple SSBs may be quasi-co-located with multiple CSI-RSs. The UE may obtain weighted averaged L1 RSRP measurements associated with the plurality of reference signals based at least in part on the configuration. The weighted averaged L1 RSRP measurements may be available as input to an ML model for beam prediction. The ML model for beam prediction may run at the UE or at the network node. For example, the UE may provide the weighted averaged L1 RSRP measurements to the ML model for beam prediction at the UE. Alternatively, the UE may transmit the weighted averaged L1 RSRP measurements to the network node. The network node may provide the weighted averaged L1 RSRP measurements to the ML model for beam prediction at the network node. When the UE applies the weighted averaging to obtain the weighted averaged L1 RSRP measurements, a beam prediction accuracy may improve, especially when an output of the ML model for beam prediction (at the UE or at the network node) is an NLOS beam prediction. In other words, when the UE and the network node are communicating via an NLOS channel, the weighted averaging may improve the beam prediction accuracy, thereby resulting in higher data rates for communications between the UE and the network node.

In some aspects, the weighted averaging of L1 RSRP measurements for the NLOS channel may reduce a randomness of an ML model input. Weighted averaged L1 RSRP measurements may be used as an input to the ML model for beam prediction (at the UE or at the network node) in an NLOS scenario, which may improve the beam prediction accuracy. Improving the beam prediction accuracy may result in a performance gain for the UE and/or the network node. Weighted averaged L1 RSRP measurements may not be needed in a line-of-sight (LOS) zone with few multi-paths. In order to enable the weighted averaged L1 RSRP measurements, the network node may provide additional CSI-RSs, where the CSI-RSs may be quasi-co-located with SSBs. The weighted averaging may be performed using L1 RSRP measurements associated with the CSI-RSs and the SSBs. For example, an SSB measurement occasion may be associated with a 20 ms periodicity. L1 RSRP measurements associated with CSI-RSs that are quasi-co-located with SSBs may occur with a 2 ms periodicity. The weighted averaging may be performed across the CSI-RSs and the SSBs. A CSI-RS may have a larger effective isotropic radiated power (EIRP) or a different bandwidth than an SSB, so weights on different reference signals (e.g., CSI-RSs versus SSBs) may be different. The UE may use the weighted averaged L1 RSRP measurements as input to a locally run ML model for beam prediction. Alternatively, the UE may report the weighted averaged L1 RSRP measurements to the network node, and the network node may use the weighted averaged L1 RSRP measurements as input to a locally run ML model for beam prediction.

FIG. 5 is a diagram illustrating an example 500 associated with applying weighted averaging to measurements associated with reference signals, in accordance with the present disclosure. As shown in FIG. 5, example 500 includes communication between a UE (e.g., UE 120) and a network node (e.g., network node 110). In some aspects, the UE and the network node may be included in a wireless network, such as wireless network 100.

As shown by reference number 502, the UE may receive, from the network node, a configuration for applying weighted averaging to L1 RSRP measurements. The configuration may indicate one or more weights and one or more parameters associated with the weighted averaging. For example, the configuration may indicate that a first type of reference signal (e.g., an SSB) is associated with a first weight, and that a second type of reference signal (e.g., CSI-RS) is associated with a second weight.

In some aspects, the UE may receive, from the network node, the configuration for applying weighted averaging to L1 RSRP measurements via RRC signaling. The UE may receive, from the network node, a medium access control control element (MAC-CE) that activates or deactivates the configuration.

In some aspects, at a first time, a channel between the UE and the network node may be an NLOS channel, which may cause random fading. The random fading may lead to a relatively high uncertainty for predicted beams. An ML model for beam prediction, at the UE or at the network node, may output an NLOS beam prediction, which may be associated with the relatively high uncertainly. In this case, the network node may transmit, to the UE, a MAC-CE that activates the configuration for applying weighted averaging to L1 RSRP measurements. The UE may apply weighted averaging to L1 RSRP measurements to reduce random fading, thereby reducing the uncertainty for predicted beams. At a second time, a channel between the UE and the network node may be an LOS channel (e.g., based at least in part on a movement of the UE). In this case, the network node may transmit, to the UE, a MAC-CE that deactivates the configuration for applying weighted averaging to L1 RSRP measurements. The UE may not need to apply the weighted averaging to L1 RSRP measurements because the LOS channel may not produce excessive randomness, and thus, an existing beam prediction accuracy may be sufficient.

As shown by reference number 504, the UE may receive, from the network node, a plurality of reference signals during a period of time. The period of time may be standard predefined or configured by the network node. The plurality of reference signals may include one or more SSBs and/or one or more CSI-RSs. The plurality of reference signals may be quasi-co-located with each other. For example, the plurality of reference signals may include an SSB and a CSI-RS, and the SSB may be quasi-co-located with the CSI-RS. In some cases, the plurality of reference signals may include one or more SSBs that are quasi-co-located with the one or more CSI-RSs. A CSI-RS may be within a defined quantity of slots of an SSB, where the weighted averaging may be over the SSB and the CSI-RS that is quasi-co-located with the SSB within the defined quantity of slots. The UE may use the same Rx filter to receive the SSB and the CSI-RS based at least in part on the CSI-RS being quasi-co-located with the SSB. In other words, the UE may use the same Rx filter to receive multiple quasi-co-located reference signals. The UE may assume the same Doppler frequency, the same Doppler spread, and/or delay spread for the for the SSB and the CSI-RS based at least in part on the CSI-RS being quasi-co-located with the SSB. In other words, the UE may assume the same Doppler frequency, the same Doppler spread, and/or delay spread for the multiple quasi-co-located reference signals. In some aspects, a reference signal in the plurality of reference signals may be associated with a weight, where the weight may be based at least in part on an EIRP value configured by the network node. For example, the SSB may be associated with the first weight and the CSI-RS may be associated with the second weight based at least in part on EIRPs configured by the network node. The plurality of reference signals may include a periodic SSB, a periodic CSI-RS, a semi-persistent CSI-RS, an aperiodic CSI-RS, and/or an on-demand SSB.

As shown by reference number 506, the UE may obtain weighted averaged L1 RSRP measurements associated with the plurality of reference signals based at least in part on the configuration. The weighted averaged L1 RSRP measurements may be associated with the SSB and the CSI-RS received from the network node, where the CSI-RS may be quasi-co-located with the SSB. The weighted averaged L1 RSRP measurements may be available as input to the ML model for beam prediction (at the UE or at the network node).

In some aspects, the network node may configure the UE to apply the weighted averaging to the L1 RSRP measurements from different reference signals received within a period of time. The reference signals may include SSBs. The reference signals may include periodic, semi-persistent, and/or aperiodic CSI-RSs. The reference signals may include on-demand SSBs. The UE may apply the weighted averaging to certain reference signals based at least in part on the configuration received from the network node, or based at least in part on a set of rules. In other words, the network node may configure for which reference signals the weighted averaging should be applied, or the reference signals may be identified by the set of rules. For example, the set of rules may indicate that the UE is to average L1 RSRP measurements of reference signals that are quasi-co-located with an SSB and are within X slots of the SSB. The UE may apply the weighted averaging to the L1 RSRP measurements from the different reference signals to obtain the weighted averaged L1 RSRP measurements.

As shown by reference number 508, the UE may provide the weighted averaged L1 RSRP measurements to the ML model for beam prediction at the UE. The weighted averaged L1 RSRP measurements may be provided as an input to the ML model for beam prediction at the UE. By inputting the weighted averaged L1 RSRP measurements, an output of the ML model for beam prediction (e.g., a predicted beam) may be less affected by random fading caused by the NLOS channel between the UE and the network node.

As shown by reference number 510, the UE may transmit, to the network node, the weighted averaged L1 RSRP measurements in an L1 RSRP beam report via a physical uplink control channel (PUCCH). The weighted averaged L1 RSRP measurements may be provided as an input to the ML model for beam prediction at the network node. By inputting the weighted averaged L1 RSRP measurements, an output of the ML model for beam prediction (e.g., a predicted beam) may be less affected by random fading caused by the NLOS channel between the network node and the UE.

In some aspects, the network node may configure a weighted averaging filter for the UE. The network node may indicate, to the UE, various weights and/or parameters associated with the weighted averaging filter. The weighted averaging filter may correspond to a finite impulse response (FIR) filter. In some aspects, the network node may turn on or turn off (or activate or deactivate) a weighted averaging filter scheme for the UE. For example, the network node may transmit, to the UE, the configuration associated with the weighted averaging filter scheme via the RRC signaling, and then the network node may use the MAC-CE to turn on or off the weighted averaging filter scheme. Alternatively, the network node may use the MAC-CE to update the weights. For example, a weight configuration of a single weight on an SSB and zero weight elsewhere may correspond to no weighted averaging.

In some aspects, the UE may receive, from the network node, an ML model configuration for applying weighted averaging to L1 RSRP measurements. The ML model configuration may be configured by the network node, and the ML model configuration may indicate instructions for applying the weighted averaging. An input port of the ML model for beam prediction may be associated with reference signals, of the plurality of reference signals, that are quasi-co-located, and the configuration may provide a set of weights for weighted averaging over the reference signals. An input port of the ML model for beam prediction may be associated with a transmission configuration indicator (TCI). The configuration may indicate the period of time and a periodicity. Reference signals, of the plurality of reference signals, that are quasi-co-located to the TCI may be averaged with the period of time based at least in part on the periodicity.

In some aspects, a weighted averaging configuration may be part of the ML model configuration transmitted by the network node to the UE. The ML model configuration may be associated with the ML model for beam prediction at the UE. Each input port of the ML model for beam prediction may be associated with multiple reference signals which are quasi-co-located, and a set of weights may be provided for averaging over the associated reference signals. Each input port of the ML model for beam prediction may be associated with a TCI, where a time duration X and a periodicity may be provided by the network node, and the UE may average a plurality of received reference signals (e.g., all reference signals) quasi-co-located to the TCI with the X time duration based at least in part on the periodicity.

In some aspects, the weighted averaged L1 RSRP measurements may be used as an input to the ML model for beam prediction, which may be run at the UE. The weighted averaged L1 RSRP measurements may be used as the input to the ML model for beam prediction to predict upcoming RSRP measurements. The ML model for beam prediction may be configured by the network node. In some aspects, the UE may transmit the weighted averaged measurements to the network node, for example, in an L1 beam report. The network node may use the weighted averaged L1 RSRP measurements (or reported results) for beam prediction. In this case, the network node may locally run the ML model for beam prediction, and the weighted averaged L1 RSRP measurements may be an input to the ML model for beam prediction running at the network node.

In some aspects, weighted averaging over L1 RSRP measurements may be different than a time averaging of L3 RSRP measurements. The UE may perform an infinite impulse response (IIR) filter on top of L1 RSRP measurements to compute the L3 RSRP measurements. The time averaging of L3 RSRP measurements may be performed via BR filtering on a single reference signal (e.g., periodic SSBs) over a relatively long period of time, whereas the weighted averaging over L1 RSRP measurements may involve a local averaging of RSRP measurements over multiple reference signals (e.g., FIR filtering over an SSB and its quasi-co-located CSI-RSs within X slots). Configuring the weighted averaging over multiple quasi-co-located CSI-RSs within the X slots may involve new signaling, as compared to the time averaging of L3 RSRP measurements. The network node may need to configure the quasi-co-located CSI-RSs within the X slots of the SSB for the UE to perform the weighted averaging over L1 RSRP measurements, whereas for the time averaging of L3 RSRP measurements, such CSI-RSs are not provided for local averaging. Further, an L3 RSRP measurement may be for an L3 report in a MAC-CE, whereas the weighted averaging over L1 RSRP measurements may be used as an input for a configured ML model for beam prediction at the UE, or for an L1 RSRP beam report in a PUCCH.

As indicated above, FIG. 5 is provided as an example. Other examples may differ from what is described with regard to FIG. 5.

FIG. 6 is a diagram illustrating an example process 600 performed, for example, by a UE, in accordance with the present disclosure. Example process 600 is an example where the UE (e.g., UE 120) performs operations associated with applying weighted averaging to measurements associated with reference signals.

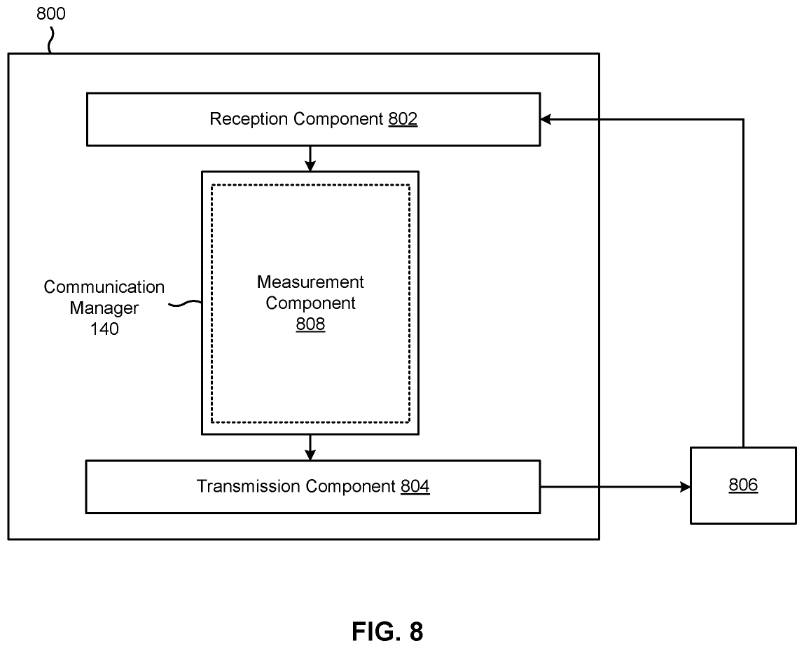

As shown in FIG. 6, in some aspects, process 600 may include receiving, from a network node, a configuration for applying weighted averaging to L1 RSRP measurements (block 610). For example, the UE (e.g., using communication manager 140 and/or reception component 802, depicted in FIG. 8) may receive, from a network node, a configuration for applying weighted averaging to L1 RSRP measurements, as described above.

As further shown in FIG. 6, in some aspects, process 600 may include receiving, from the network node, a plurality of reference signals during a period of time, the plurality of reference signals being quasi-co-located with each other (block 620). For example, the UE (e.g., using communication manager 140 and/or reception component 802, depicted in FIG. 8) may receive, from the network node, a plurality of reference signals during a period of time, the plurality of reference signals being quasi-co-located with each other, as described above.

As further shown in FIG. 6, in some aspects, process 600 may include obtaining weighted averaged L1 RSRP measurements associated with the plurality of reference signals based at least in part on the configuration, the weighted averaged L1 RSRP measurements being available as input to an ML model for beam prediction (block 630). For example, the UE (e.g., using communication manager 140 and/or measurement component 808, depicted in FIG. 8) may obtain weighted averaged L1 RSRP measurements associated with the plurality of reference signals based at least in part on the configuration, the weighted averaged L1 RSRP measurements being available as input to an ML model for beam prediction, as described above.

Process 600 may include additional aspects, such as any single aspect or any combination of aspects described below and/or in connection with one or more other processes described elsewhere herein.

In a first aspect, process 600 includes transmitting, to the network node, the weighted averaged L1 RSRP measurements in an L1 RSRP beam report via an uplink control channel.

In a second aspect, alone or in combination with the first aspect, a reference signal in the plurality of reference signals is associated with a weight, and the weight is based at least in part on an EIRP value configured by the network node.

In a third aspect, alone or in combination with one or more of the first and second aspects, the period of time is standard predefined or configured by the network node, and the ML model for beam prediction is run at the UE or at the network node.

In a fourth aspect, alone or in combination with one or more of the first through third aspects, the plurality of reference signals includes one or more of: a periodic SSB, a periodic CSI-RS, a semi-persistent CSI-RS, an aperiodic CSI-RS, or an on-demand SSB.

In a fifth aspect, alone or in combination with one or more of the first through fourth aspects, the plurality of reference signals includes an SSB and a CSI-RS, wherein the SSB is quasi-co-located with the CSI-RS, and the CSI-RS is within a predefined quantity of slots of the SSB.

In a sixth aspect, alone or in combination with one or more of the first through fifth aspects, the configuration indicates one or more weights and one or more parameters associated with the weighted averaging.

In a seventh aspect, alone or in combination with one or more of the first through sixth aspects, the configuration for applying weighted averaging to L1 RSRP measurements is received via RRC signaling, and process 600 includes receiving, from the network node, a MAC-CE that activates or deactivates the configuration.

In an eighth aspect, alone or in combination with one or more of the first through seventh aspects, process 600 includes receiving, from the network node, an ML model configuration for applying weighted averaging to L1 RSRP measurements.

In a ninth aspect, alone or in combination with one or more of the first through eighth aspects, an input port of the ML model for beam prediction is associated with reference signals, of the plurality of reference signals, that are quasi-co-located, and wherein the configuration provides a set of weights for weighted averaging over the reference signals.

In a tenth aspect, alone or in combination with one or more of the first through ninth aspects, an input port of the ML model for beam prediction is associated with a TCI, wherein the configuration indicates the period of time and a periodicity, and wherein reference signals, of the plurality of reference signals, that are quasi-co-located to the TCI are averaged with the period of time based at least in part on the periodicity.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, by a network node, in accordance with the present disclosure. Example process 700 is an example where the network node (e.g., network node 110) performs operations associated with applying weighted averaging to measurements associated with reference signals.

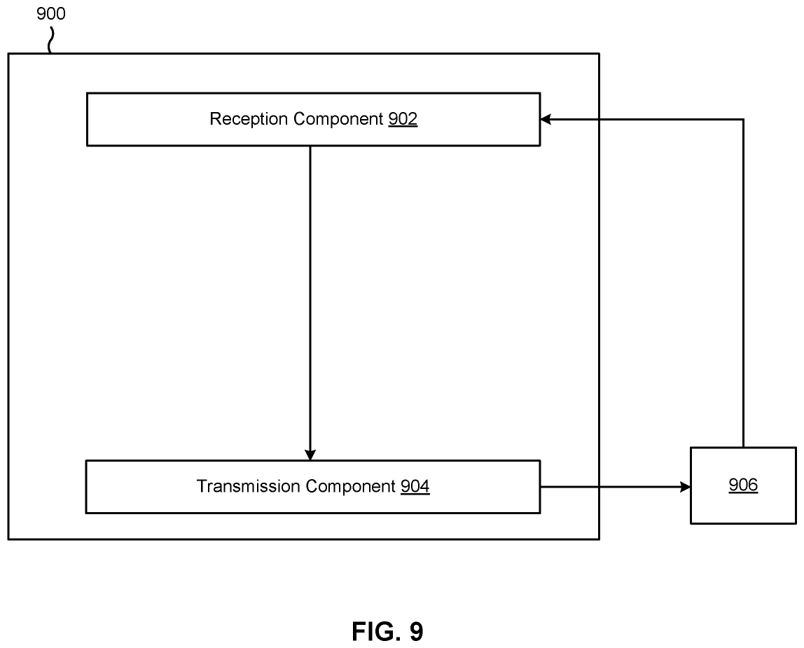

As shown in FIG. 7, in some aspects, process 700 may include transmitting, to a UE, a configuration for applying weighted averaging to L1 RSRP measurements (block 710). For example, the network node (e.g., using transmission component 904, depicted in FIG. 9) may transmit, to a UE, a configuration for applying weighted averaging to L1 RSRP measurements, as described above.

As further shown in FIG. 7, in some aspects, process 700 may include transmitting, to the UE, a plurality of reference signals during a period of time, the plurality of reference signals being quasi-co-located with each other (block 720). For example, the network node (e.g., using transmission component 904, depicted in FIG. 9) may transmit, to the UE, a plurality of reference signals during a period of time, the plurality of reference signals being quasi-co-located with each other, as described above.

As further shown in FIG. 7, in some aspects, process 700 may include receiving, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction (block 730). For example, the network node (e.g., using reception component 902, depicted in FIG. 9) may receive, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction, as described above.

Process 700 may include additional aspects, such as any single aspect or any combination of aspects described below and/or in connection with one or more other processes described elsewhere herein.

In a first aspect, a reference signal in the plurality of reference signals is associated with a weight, and the weight is based at least in part on an EIRP value configured by the network node.

In a second aspect, alone or in combination with the first aspect, the period of time is standard predefined or configured by the network node, and the ML model for beam prediction is run at the UE or at the network node.

In a third aspect, alone or in combination with one or more of the first and second aspects, the plurality of reference signals includes one or more of a periodic SSB, a periodic CSI-RS, a semi-persistent CSI-RS, an aperiodic CSI-RS, or an on-demand SSB.

In a fourth aspect, alone or in combination with one or more of the first through third aspects, the plurality of reference signals includes an SSB and a CSI-RS, wherein the SSB is quasi-co-located with the CSI-RS, and the CSI-RS is within a predefined quantity of slots of the SSB.

In a fifth aspect, alone or in combination with one or more of the first through fourth aspects, the configuration indicates one or more weights and one or more parameters associated with the weighted averaging.

In a sixth aspect, alone or in combination with one or more of the first through fifth aspects, the configuration for applying weighted averaging to L1 RSRP measurements is transmitted via RRC signaling, and process 700 includes transmitting, to the UE, a MAC-CE that activates or deactivates the configuration.

In a seventh aspect, alone or in combination with one or more of the first through sixth aspects, process 700 includes transmitting, to the UE, an ML model configuration for applying weighted averaging to L1 RSRP measurements.

In an eighth aspect, alone or in combination with one or more of the first through seventh aspects, an input port of the ML model for beam prediction is associated with reference signals, of the plurality of reference signals, that are quasi-co-located, and wherein the configuration provides a set of weights for weighted averaging over the reference signals.

In a ninth aspect, alone or in combination with one or more of the first through eighth aspects, an input port of the ML model for beam prediction is associated with a TCI, wherein the configuration indicates the period of time and a periodicity, and wherein reference signals, of the plurality of reference signals, that are quasi-co-located to the TCI are averaged with the period of time based at least in part on the periodicity.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include a measurement component 808, among other examples.

In some aspects, the apparatus 800 may be configured to perform one or more operations described herein in connection with FIG. 5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive, from a network node, a configuration for applying weighted averaging to L1 RSRP measurements. The reception component 802 may receive, from the network node, a plurality of reference signals during a period of time, the plurality of reference signals being quasi-co-located with each other. The measurement component 808 may obtain weighted averaged L1 RSRP measurements associated with the plurality of reference signals based at least in part on the configuration, the weighted averaged L1 RSRP measurements being available as input to an ML model for beam prediction.

The transmission component 804 may transmit, to the network node, the weighted averaged L1 RSRP measurements in an L1 RSRP beam report via an uplink control channel. The reception component 802 may receive, from the network node, an ML model configuration for applying weighted averaging to L1 RSRP measurements.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a network node, or a network node may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904.

In some aspects, the apparatus 900 may be configured to perform one or more operations described herein in connection with FIG. 5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network node described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network node described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the network node described in connection with FIG. 2. In some aspects, the transmission component 904 may be co-located with the reception component 902 in a transceiver.

The transmission component 904 may transmit, to a UE, a configuration for applying weighted averaging to L1 RSRP measurements. The transmission component 904 may transmit, to the UE, a plurality of reference signals during a period of time, the plurality of reference signals being quasi-co-located with each other. The reception component 902 may receive, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to an ML model for beam prediction. The transmission component 904 may transmit, to the UE, an ML model configuration for applying weighted averaging to L1 RSRP measurements.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by an apparatus of a user equipment (UE), comprising: receiving, from a network node, a configuration for applying weighted averaging to layer 1 (L1) reference signal received power (RSRP) measurements; receiving, from the network node, a plurality of reference signals during a period of time, the plurality of reference signals being quasi-co-located with each other; and obtaining weighted averaged L1 RSRP measurements associated with the plurality of reference signals based at least in part on the configuration, the weighted averaged L1 RSRP measurements being available as input to a machine learning (ML) model for beam prediction.

Aspect 2: The method of Aspect 1, further comprising: transmitting, to the network node, the weighted averaged L1 RSRP measurements in an L1 RSRP beam report via an uplink control channel.

Aspect 3: The method of any of Aspects 1 through 2, wherein a reference signal in the plurality of reference signals is associated with a weight, and wherein the weight is based at least in part on an effective isotropic radiated power value configured by the network node.

Aspect 4: The method of any of Aspects 1 through 3, wherein the period of time is standard predefined or configured by the network node, and wherein the ML model for beam prediction is run at the UE or at the network node.

Aspect 5: The method of any of Aspects 1 through 4, wherein the plurality of reference signals includes one or more of: a periodic synchronization signal block (SSB), a periodic channel state information reference signal (CSI-RS), a semi-persistent CSI-RS, an aperiodic CSI-RS, or an on-demand SSB.

Aspect 6: The method of any of Aspects 1 through 5, wherein the plurality of reference signals includes a synchronization signal block (SSB) and a channel state information reference signal (CSI-RS), wherein the SSB is quasi-co-located with the CSI-RS, and wherein the CSI-RS is within a predefined quantity of slots of the SSB.

Aspect 7: The method of any of Aspects 1 through 6, wherein the configuration indicates one or more weights and one or more parameters associated with the weighted averaging.

Aspect 8: The method of any of Aspects 1 through 7, wherein the configuration for applying weighted averaging to L1 RSRP measurements is received via radio resource control (RRC) signaling, and further comprising: receiving, from the network node, a medium access control control element (MAC-CE) that activates or deactivates the configuration.

Aspect 9: The method of any of Aspects 1 through 8, further comprising: receiving, from the network node, an ML model configuration for applying weighted averaging to L1 RSRP measurements.

Aspect 10: The method of any of Aspects 1 through 9, wherein an input port of the ML model for beam prediction is associated with reference signals, of the plurality of reference signals, that are quasi-co-located, and wherein the configuration provides a set of weights for weighted averaging over the reference signals.

Aspect 11: The method of any of Aspects 1 through 10, wherein an input port of the ML model for beam prediction is associated with a transmission configuration indicator (TCI), wherein the configuration indicates the period of time and a periodicity, and wherein reference signals, of the plurality of reference signals, that are quasi-co-located to the TCI are averaged with the period of time based at least in part on the periodicity.

Aspect 12: A method of wireless communication performed by an apparatus of a network node, comprising: transmitting, to a user equipment (UE), a configuration for applying weighted averaging to layer 1 (L1) reference signal received power (RSRP) measurements; transmitting, to the UE, a plurality of reference signals during a period of time, the plurality of reference signals being quasi-co-located with each other; and receiving, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to a machine learning (ML) model for beam prediction.

Aspect 13: The method of Aspect 12, wherein a reference signal in the plurality of reference signals is associated with a weight, and wherein the weight is based at least in part on an effective isotropic radiated power value configured by the network node.

Aspect 14: The method of any of Aspects 12 through 13, wherein the period of time is standard predefined or configured by the network node, and wherein the ML model for beam prediction is run at the UE or at the network node.

Aspect 15: The method of any of Aspects 12 through 14, wherein the plurality of reference signals includes one or more of: a periodic synchronization signal block (SSB), a periodic channel state information reference signal (CSI-RS), a semi-persistent CSI-RS, an aperiodic CSI-RS, or an on-demand SSB.

Aspect 16: The method of any of Aspects 12 through 15, wherein the plurality of reference signals includes a synchronization signal block (SSB) and a channel state information reference signal (CSI-RS), wherein the SSB is quasi-co-located with the CSI-RS, and wherein the CSI-RS is within a predefined quantity of slots of the SSB.

Aspect 17: The method of any of Aspects 12 through 16, wherein the configuration indicates one or more weights and one or more parameters associated with the weighted averaging.

Aspect 18: The method of any of Aspects 12 through 17, wherein the configuration for applying weighted averaging to L1 RSRP measurements is transmitted via radio resource control (RRC) signaling, and further comprising: transmitting, to the UE, a medium access control control element (MAC-CE) that activates or deactivates the configuration.

Aspect 19: The method of any of Aspects 12 through 18, further comprising: transmitting, to the UE, an ML model configuration for applying weighted averaging to L1 RSRP measurements.

Aspect 20: The method of any of Aspects 12 through 19, wherein an input port of the ML model for beam prediction is associated with reference signals, of the plurality of reference signals, that are quasi-co-located, and wherein the configuration provides a set of weights for weighted averaging over the reference signals.

Aspect 21: The method of any of Aspects 12 through 20, wherein an input port of the ML model for beam prediction is associated with a transmission configuration indicator (TCI), wherein the configuration indicates the period of time and a periodicity, and wherein reference signals, of the plurality of reference signals, that are quasi-co-located to the TCI are averaged with the period of time based at least in part on the periodicity.

Aspect 22: An apparatus for wireless communication at a device, comprising a processor; memory coupled with the processor; and instructions stored in the memory and executable by the processor to cause the apparatus to perform the method of one or more of Aspects 1-11.

Aspect 23: A device for wireless communication, comprising a memory and one or more processors coupled to the memory, the one or more processors configured to perform the method of one or more of Aspects 1-11.

Aspect 24: An apparatus for wireless communication, comprising at least one means for performing the method of one or more of Aspects 1-11.

Aspect 25: A non-transitory computer-readable medium storing code for wireless communication, the code comprising instructions executable by a processor to perform the method of one or more of Aspects 1-11.

Aspect 26: A non-transitory computer-readable medium storing a set of instructions for wireless communication, the set of instructions comprising one or more instructions that, when executed by one or more processors of a device, cause the device to perform the method of one or more of Aspects 1-11.

Aspect 27: An apparatus for wireless communication at a device, comprising a processor; memory coupled with the processor; and instructions stored in the memory and executable by the processor to cause the apparatus to perform the method of one or more of Aspects 12-21.

Aspect 28: A device for wireless communication, comprising a memory and one or more processors coupled to the memory, the one or more processors configured to perform the method of one or more of Aspects 12-21.

Aspect 29: An apparatus for wireless communication, comprising at least one means for performing the method of one or more of Aspects 12-21.

Aspect 30: A non-transitory computer-readable medium storing code for wireless communication, the code comprising instructions executable by a processor to perform the method of one or more of Aspects 12-21.

Aspect 31: A non-transitory computer-readable medium storing a set of instructions for wireless communication, the set of instructions comprising one or more instructions that, when executed by one or more processors of a device, cause the device to perform the method of one or more of Aspects 12-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive, from a network node, a configuration for applying weighted averaging to layer 1 (L1) reference signal received power (RSRP) measurements;
receive, from the network node, a plurality of reference signals during a period of time, the plurality of reference signals being quasi-co-located with each other; and
obtain weighted averaged L1 RSRP measurements associated with the plurality of reference signals based at least in part on the configuration, the weighted averaged L1 RSRP measurements being available as input to a machine learning (ML) model for beam prediction.

2. The apparatus of claim 1, wherein the one or more processors are further configured to:
transmit, to the network node, the weighted averaged L1 RSRP measurements in an L1 RSRP beam report via an uplink control channel.

3. The apparatus of claim 1, wherein a reference signal in the plurality of reference signals is associated with a weight, and wherein the weight is based at least in part on an effective isotropic radiated power value configured by the network node.

4. The apparatus of claim 1, wherein the period of time is standard predefined or configured by the network node, and wherein the ML model for beam prediction is run at the UE or at the network node.

5. The apparatus of claim 1, wherein the plurality of reference signals includes one or more of: a periodic synchronization signal block (SSB), a periodic channel state information reference signal (CSI-RS), a semi-persistent CSI-RS, an aperiodic CSI-RS, or an on-demand SSB.

6. The apparatus of claim 1, wherein the plurality of reference signals includes a synchronization signal block (SSB) and a channel state information reference signal (CSI-RS), wherein the SSB is quasi-co-located with the CSI-RS, and wherein the CSI-RS is within a predefined quantity of slots of the SSB.

7. The apparatus of claim 1, wherein the configuration indicates one or more weights and one or more parameters associated with the weighted averaging.

8. The apparatus of claim 1, wherein the one or more processors are further configured to:
receive, from the network node, the configuration for applying weighted averaging to L1 RSRP measurements via radio resource control (RRC) signaling; and
receive, from the network node, a medium access control control element (MAC-CE) that activates or deactivates the configuration.

9. The apparatus of claim 1, wherein the one or more processors are further configured to:
receive, from the network node, an ML model configuration for applying weighted averaging to L1 RSRP measurements.

10. The apparatus of claim 1, wherein an input port of the ML model for beam prediction is associated with reference signals, of the plurality of reference signals, that are quasi-co-located, and wherein the configuration provides a set of weights for weighted averaging over the reference signals.

11. The apparatus of claim 1, wherein an input port of the ML model for beam prediction is associated with a transmission configuration indicator (TCI), wherein the configuration indicates the period of time and a periodicity, and wherein reference signals, of the plurality of reference signals, that are quasi-co-located to the TCI are averaged with the period of time based at least in part on the periodicity.

12. An apparatus for wireless communication at a network node, comprising:
a memory; and
one or more processors, coupled to the memory, configured to:
transmit, to a user equipment (UE), a configuration for applying weighted averaging to layer 1 (L1) reference signal received power (RSRP) measurements;
transmit, to the UE, a plurality of reference signals during a period of time, the plurality of reference signals being quasi-co-located with each other; and
receive, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to a machine learning (ML) model for beam prediction.

13. The apparatus of claim 12, wherein a reference signal in the plurality of reference signals is associated with a weight, and wherein the weight is based at least in part on an effective isotropic radiated power value configured by the network node.

14. The apparatus of claim 12, wherein the period of time is standard predefined or configured by the network node, and wherein the ML model for beam prediction is run at the UE or at the network node.

15. The apparatus of claim 12, wherein the plurality of reference signals includes one or more of: a periodic synchronization signal block (SSB), a periodic channel state information reference signal (CSI-RS), a semi-persistent CSI-RS, an aperiodic CSI-RS, or an on-demand SSB.

16. The apparatus of claim 12, wherein the plurality of reference signals includes a synchronization signal block (SSB) and a channel state information reference signal (CSI-RS), wherein the SSB is quasi-co-located with the CSI-RS, and wherein the CSI-RS is within a predefined quantity of slots of the SSB.

17. The apparatus of claim 12, wherein the configuration indicates one or more weights and one or more parameters associated with the weighted averaging.

18. The apparatus of claim 12, wherein the one or more processors are further configured to:
transmit, to the UE, the configuration for applying weighted averaging to L1 RSRP measurements via radio resource control (RRC) signaling; and
transmit, to the UE, a medium access control control element (MAC-CE) that activates or deactivates the configuration.

19. The apparatus of claim 12, wherein the one or more processors are further configured to:
transmit, to the UE, an ML model configuration for applying weighted averaging to L1 RSRP measurements.

20. The apparatus of claim 12, wherein an input port of the ML model for beam prediction is associated with reference signals, of the plurality of reference signals, that are quasi-co-located, and wherein the configuration provides a set of weights for weighted averaging over the reference signals.

21. The apparatus of claim 12, wherein an input port of the ML model for beam prediction is associated with a transmission configuration indicator (TCI), wherein the configuration indicates the period of time and a periodicity, and wherein reference signals, of the plurality of reference signals, that are quasi-co-located to the TCI are averaged with the period of time based at least in part on the periodicity.

22. A method of wireless communication performed by an apparatus of a user equipment (UE), comprising:
receiving, from a network node, a configuration for applying weighted averaging to layer 1 (L1) reference signal received power (RSRP) measurements;
receiving, from the network node, a plurality of reference signals during a period of time, the plurality of reference signals being quasi-co-located with each other; and
obtaining weighted averaged L1 RSRP measurements associated with the plurality of reference signals based at least in part on the configuration, the weighted averaged L1 RSRP measurements being available as input to a machine learning (ML) model for beam prediction.

23. The method of claim 22, further comprising:
transmitting, to the network node, the weighted averaged L1 RSRP measurements in an L1 RSRP beam report via an uplink control channel.

24. The method of claim 22, wherein the plurality of reference signals includes a synchronization signal block (SSB) and a channel state information reference signal (CSI-RS), wherein the SSB is quasi-co-located with the CSI-RS, and wherein the CSI-RS is within a predefined quantity of slots of the SSB.

25. The method of claim 22, wherein the configuration for applying weighted averaging to L1 RSRP measurements is received via radio resource control (RRC) signaling, and further comprising:
receiving, from the network node, a medium access control control element (MAC-CE) that activates or deactivates the configuration.

26. The method of claim 22, further comprising:
receiving, from the network node, an ML model configuration for applying weighted averaging to L1 RSRP measurements.

27. A method of wireless communication performed by an apparatus of a network node, comprising:
transmitting, to a user equipment (UE), a configuration for applying weighted averaging to layer 1 (L1) reference signal received power (RSRP) measurements;
transmitting, to the UE, a plurality of reference signals during a period of time, the plurality of reference signals being quasi-co-located with each other; and
receiving, from the UE and via an uplink control channel, an L1 RSRP beam report that indicates weighted averaged L1 RSRP measurements associated with the plurality of reference signals, the weighted averaged L1 RSRP measurements being obtained based at least in part on the configuration, and the weighted averaged L1 RSRP measurements being available as input to a machine learning (ML) model for beam prediction.

28. The method of claim 27, wherein the plurality of reference signals includes a synchronization signal block (SSB) and a channel state information reference signal (CSI-RS), wherein the SSB is quasi-co-located with the CSI-RS, and wherein the CSI-RS is within a predefined quantity of slots of the SSB.

29. The method of claim 27, wherein the configuration for applying weighted averaging to L1 RSRP measurements is transmitted via radio resource control (RRC) signaling, and further comprising:
transmitting, to the UE, a medium access control control element (MAC-CE) that activates or deactivates the configuration.

30. The method of claim 27, further comprising:
transmitting, to the UE, an ML model configuration for applying weighted averaging to L1 RSRP measurements.
